(19) United States
(12) Patent Application Publication
(10) Pub. No.: US 2013/0155097 A1
(43) Pub. Date: Jun. 20, 2013

(54) METHOD AND APPARATUS FOR MULTIPLE VIRTUAL THEMES FOR A USER INTERFACE (UI)

(71) Applicant: Wayne C. Louie, Port Perry (CA)

(72) Inventor: Wayne C. Louie, Port Perry (CA)

(73) Assignee: ATI TECHNOLOGIES ULC, Markham (CA)

(21) Appl. No.: 13/327,024

(22) Filed: Dec. 15, 2011

(51) Int. Cl. G09G 5/00

(52) U.S. Cl. 345/619

(57) ABSTRACT

A method and apparatus for creating one or more themed user interfaces (UI) each capable of displaying content unique to the theme selected. This may allow the use of the one or more display configurations for themed content. A device may be associated with a UI, which is capable of displaying content. One or more display configurations associated with one or more themes may be created. Upon selection of a particular theme, content specific to the particular theme is displayed via the associated display configuration.

### FIELD OF INVENTION

The present invention is generally directed to image processing and, more particularly, to a user interface (UI) for selectively implementing multiple virtual themes.

### BACKGROUND

A user of a computing device that includes a display feature, for example, a personal computer (PC) or mobile device (e.g., notebook, smartphone, tablet, etc.) that is associated with a single monitor, may desire to change the content and layout of the display feature. Display features typically host a fixed set of regions of static content while providing paging and search functions. While it is possible to change the content of the display feature through pagination (e.g., paging between display screens or opening new windows) and search functions, organization of information into easy to find and convenient display configurations has become more difficult.

### SUMMARY OF EMBODIMENTS

A method and apparatus for switching content displayed by a user device between one or more themes. One or more display configurations and the one or more themes may be created. The one or more display configurations may be associated with the one or more themes. Upon selection of a particular theme, content specific to the particular theme is displayed via the associated display configuration in the UI.

### DETAILED DESCRIPTION OF THE DRAWINGS

A more detailed understanding may be had from the following description, given by way of example in conjunction with the accompanying drawings wherein:

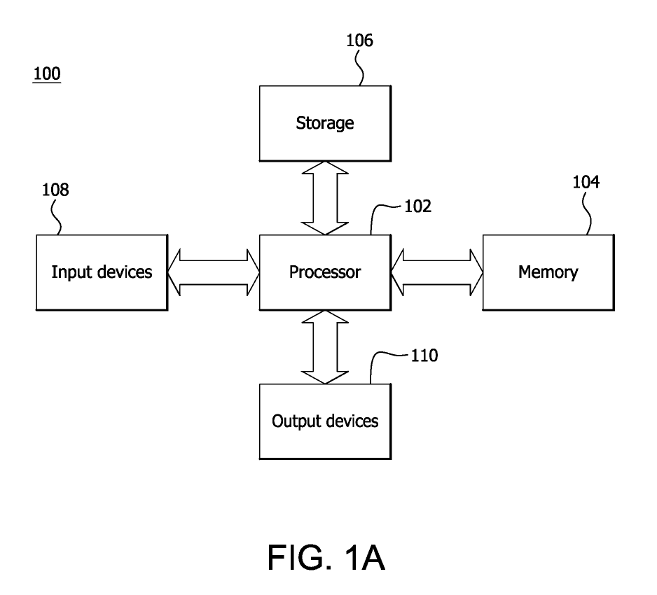

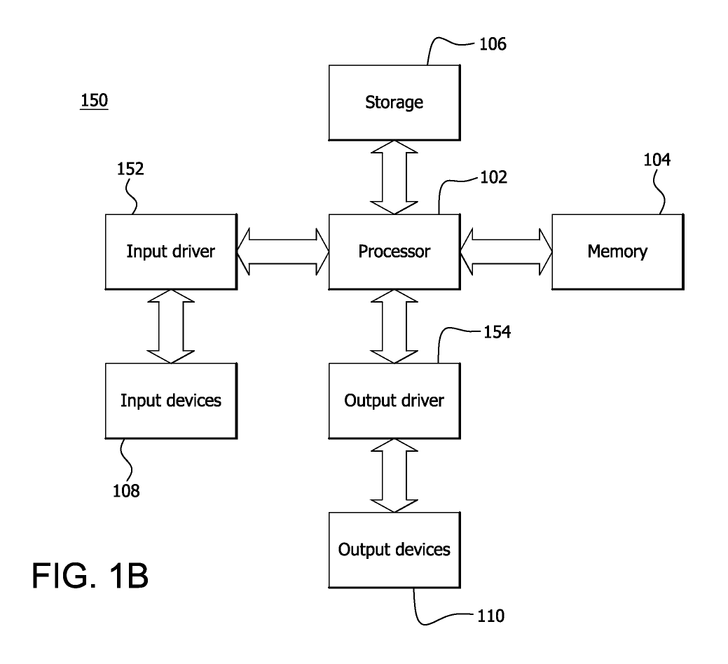

FIG. 1A is a block diagram of an example device in which one or more disclosed embodiments may be implemented;

FIG. 1B is a block diagram of an alternate example device in which one or more disclosed embodiments may be implemented;

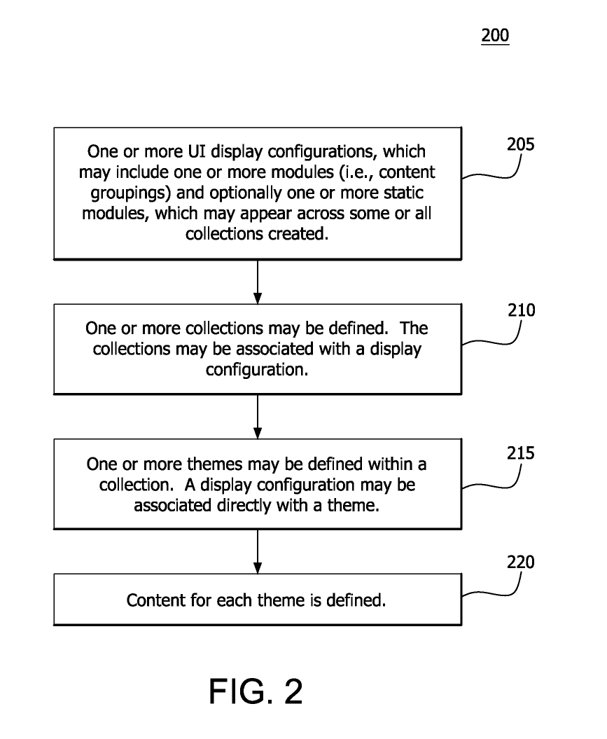

FIG. 2 is a flow diagram for configuration of UI display configurations, collections and themes;

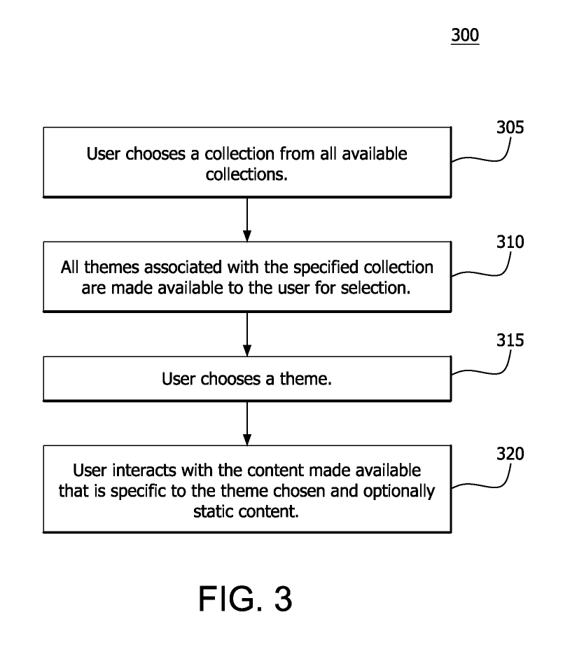

FIG. 3 is a flow diagram of the process flow of displaying a theme and theme related content;

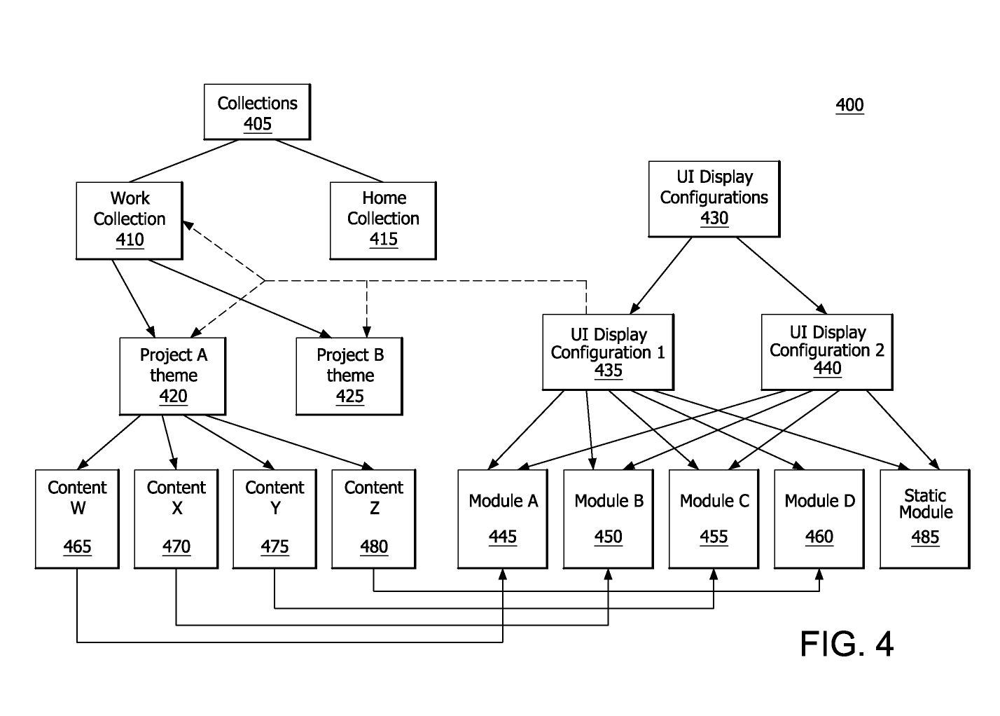

FIG. 4 is a block diagram of the display of a theme;

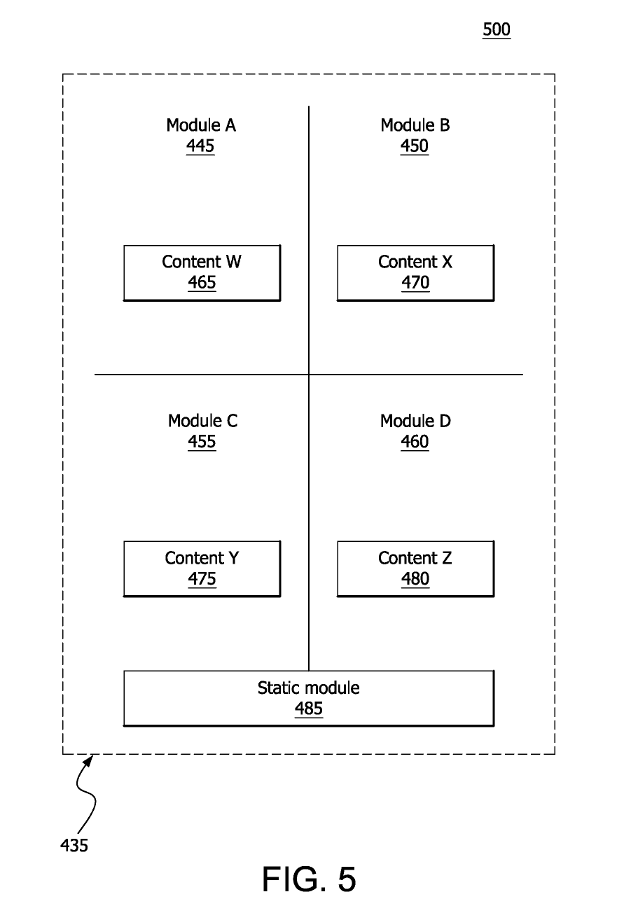

FIG. 5 is a block diagram of a UI display; and

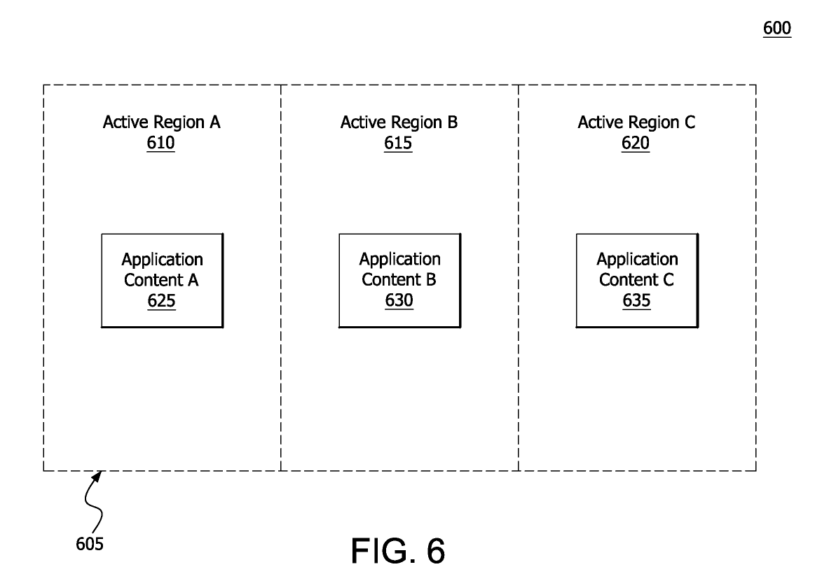

FIG. 6 is a block diagram of a UI with multiple active regions.

### BRIEF DESCRIPTION OF EMBODIMENTS

FIG. 1A is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. It is understood that the device 100 may include additional components not shown in FIG. 1A. Each of the memory 104, the storage 106, the one or more input devices 108 and the one or more output devices 110 are communicatively coupled to the processor 102, which controls the operation of the device 100.

The processor 102 may include a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

FIG. 1B is a block diagram of an alternate example device 150 in which one or more disclosed embodiments may be implemented. Elements of the device 150 which are the same as in the device 100 are given like reference numbers. In addition to the processor 102, the memory 104, the storage 106, the input devices 108, and the output devices 110, the device 150 also includes an input driver 152 and an output driver 154.

The input driver 152 communicates with the processor 102 and the input devices 108, and permits the processor 102 to receive input from and control the input devices 108 via an input driver 152. The output driver 154 communicates with the processor 102 and the output devices 110, and permits the processor 102 to send output to and control the output devices 110 via output driver 154.

A device 100 and/or 150 may display information using one or many display configurations. A display configuration includes, for example, display organization of content (e.g., placing of content within specific windows, folders, pages and the like), the content being accessible within the display organization. For example, certain content may only be available within a specific organization (or the content may be configured or have access rights expanded or restricted within a particular organization). Examples of configuring content may include adjusting the functions accessible within a particular application depending upon the display configuration.

As described in greater detail below, an application may be part of both a work related display configuration and personal related configuration for a selected user. If, for example, that application is a financial data related application (e.g., an accounting application) certain aspects of the functionality of the application (e.g., the corporate tax functionality) may configured to be accessible only in the work related display configurations while the personal federal and state income tax functionality of that same application may only be accessible within personal related display configurations. As described in greater detail below, a module (which may include an application, files, etc.) may be configured to adjust functionality provided by that module in a variety ways depending upon the theme associated with the display configuration. If the module is primarily data (e.g., a file or a folder), functionality associated with the module may be configured by altering the accessibility of data (e.g., viewability), editing permissions, copying and the like. Other similar adjustments to other types of modules can equally be made as will be appreciated by a person of ordinary skill. For example, a personal computer may be associated with a monitor for the display of information. The information may be displayed on the monitor using one or more display configurations predetermined by a user. As shown in Table 1, a display configuration may include one or more modules. Modules are groupings of content that appear within a display. For example, a module may include a grouping of content such as, but not limited to, one or more items (e.g., files, folders, applications, drives, internet shares, web links, file systems, physical and logical devices such as, but not limited to, servers, computers, media players, PDAs, phones, gaming controllers), as well as references to such items (e.g., shortcuts, icons, tiles). In addition, a module may contain static content.

TABLE 1

| | |
|---|---|
| Display Configuration 1 | Module A |
| | Module B |
| | Module C |
| | Module D |
| | Static Module |
| Display Configuration 2 | Module A |
| | Module B |
| | Module C |
| | Static Module |

A user may also create one or more collections. A collection includes a category created by a user to define a particular area of interest for which a unique display of information may be needed. For example, a collection may be, but is not limited to, a category such as work, home, school or customers. As shown in Table 2, within each collection, one or more themes may be defined. A theme is an area of interest within the collection. For example, a theme may be various customers, work projects, classes or hobbies. Themes are associated with particular information displayed (i.e., content) on the monitor. For example, the theme “Work Finances” may be associated with content C. Content C may include financial applications, internet links to financial web sites, folders with financial data, for example, with that content relevant to the user's work (e.g., employment) or activity (in contrast to financial related content) that the user may have that is only (or primarily) relevant to his/her personal activities.

TABLE 2

| Collections | Themes | Content |
|---|---|---|
| Work | Work Project A | Content W |
| | | Content X |
| | | Content Y |
| | | Content Z |
| | Work Project B | Content A |
| | | Content B |
| | Work Finances | Content C |
| Home | Home Finances | Content D |
| | Home Travel | Content E |
| | Home Hobbies | Content F |
| | | Content G |
| School | School Class A | Content H |
| Customers | Customer A | Content I |
| | Customer B | Content J |
| | Customer C | Content K |

Content and the display configuration of the content on a monitor may vary depending upon the combination of theme and display configuration chosen by the user. Additionally, content may be included in multiple themes and multiple collections and may be displayed via one or more display configurations. For example, a financial statement document is a type of content. The financial statement may include both work and home finances and may be included in both the “Work Finances” theme and the “Home Finances” theme, which belong to the “Work” collection and “Home” collection, respectively. As shown in Table 3, “Work Finances” are displayed via Display Configuration 1, while “Home Finances” are displayed via Display Configuration 2. The financial statement may be displayed using either Display Configuration 1 or Display Configuration 2, depending upon the theme chosen. Stated another way, content=financial statement: work finances, home finances: work, home: display configuration 1, display configuration 2.

As shown in Table 3, a user may associate a particular display configuration with one or more collections or themes. Each theme within a collection may be associated with the particular display configuration for the collection. Alternatively, a theme may be associated with a particular display configuration that may not be for the collection to which the theme belongs. For example, the theme “work project B” is included in the work collection. While the work collection is associated with display configuration 1, the “work project B” theme is associated with display configuration 2 as shown in Table 3.

TABLE 3

| | |
|---|---|
| Display Configuration 1 | Work |
| | Work Project A |
| | Work Finances |
| Display Configuration 2 | Work Project B |
| | Home |
| | Home Finances |
| | Home Travel |
| | Home Hobbies |

One or more groupings of static content may appear across some or all collections, themes or subsets of themes, and may be included in some or all display configurations. When defining a new theme, the user may choose to hide one or more groupings of static content associated with a collection, or may include the static content associated with other collections or themes. For example, each collection may include its own static content, or the user may define static content that may be included in all collections. Alternatively, static content may appear in only a subset of themes and collections. For example, a link to the United States Patent and Trademark Office (USPTO) web site may appropriate to have associated with all work collections, while a link to a music application may be appropriate to have in all home collections.

FIG. 2 is a flow diagram 200 for configuration of UI display configurations, collections and themes. A user may define one or more UI display configurations 205. Each display configuration may include one or more modules 205. A module may contain static content that may appear in some or all collections 205.

One or more collections may be defined, and each collection may be associated with a specific display configuration 210. A collection may include one or more themes, wherein each theme within the collection may be associated with the specific display configuration associated with the collection, or may be associated with a different display configuration 215. A theme may include content specific to that particular theme 220.

At any point in the method of FIG. 2, additional actions may be performed within the flow diagram. The flow of FIG. 2 may be configured in any order and is not limited to the depiction in FIG. 2.

FIG. 3 is a flow diagram 300 of the process for displaying a theme and theme related content. All collections are made available to a user for selection. A user may choose a collection 305. The collection may be selected for display as, but not limited to, an icon, a list, a uniform resource locator (URL), a hot key or any type of input trigger such as plugging in a new display, switching to a new display (e.g., switch to TV output triggers “Game” theme), transitioning to/from AC and DC and closing a laptop lid. Once a collection is chosen, all themes associated with the chosen collection are made available to the user for selection 310. In addition, selecting a collection may switch the display to an initial theme that the user previously associated with the chosen collection, or the selection of a collection may make available and/or show the set of themes associated with the chosen collection. The themes may be displayed as, but are not limited to, an icon, a list, a URL, etc, or may be associated with some input trigger such as a hot key or any other type of input trigger. A theme may be chosen, which allows content specific to the theme to be displayed 215. The user may interact with the content specific to the theme and may also interact with static content that may be available to themes and collections 320.

At any point in the method of FIG. 3, additional actions may be performed within the flow diagram. The flow of FIG. 3 may be configured in any order and is not limited to the depiction in FIG. 3.

FIG. 4 is a block diagram 400 of the display of content based on a chosen theme. A user may determine to display a specific theme and the content associated with that theme. In order to display the desired content, the user chooses a collection from the one or more collections 405. For example, a collection may be a work collection 410 or a home collection 415. On a condition that the user chooses a collection, (e.g., work collection 410), the themes associated with that collection are made available for selection, possibly without changing the currently displayed theme and the content associated with that theme. For example, a portion of the display may allow a user to navigate to themes via the selection of a collection. Alternatively, the user may be presented with a flat list of themes from all collections, or the user may be presented with a hot key that may be used to switch from one collection to another, which may affect theme selection from the newly available collection.

The themes in the chosen work collection 410 may include a project A theme 420 and a project B theme 425, for example. On a condition that the project A theme 420 is chosen, content specific to the project A theme 420 is made available. For example, project A may include content W 465, content X 470, content Y 475 and content Z 480.

Content is made available via modules set up in a particular UI display configuration. UI display configurations are user defined groupings of one or more modules in a particular arrangement. One or more UI display configurations 430 may be created. For example, UI display configuration 1 435 and UI display configuration 2 440 may be created by a user. UI display configuration 1 435 may include module A 445, module B 450, module C 455 and module D 460.

UI display configurations 430 may be associated with a particular theme directly or may be associated with the collection to which the theme belongs. For example, the work collection 410 may be associated with UI display configuration 1 435. The themes, project A 420 and project B 425 may also be associated with UI display configuration 1 435, based on their association with work collection 410. Alternatively, project A 420 may be associated with UI display configuration 2 440 regardless of the work collection 410 association with UI display configuration 1 435.

Upon selection of a theme, which is associated with a particular UI display configuration, some or all of the content related to the selected theme may be made available in the UI display configuration's modules. For example, project A 420 may include content W 465, content X 470, content Y 475 and content Z 480. Project A 420 may be associated with UI display configuration 1 435 which includes module A 445, module B 450, module C 455 and module D 460. Project A's 420 content W 465, content X 470, content Y 475 and content Z 480 are associated with particular modules of the UI display configuration 1 435. Upon selection of project A 420, content W 465 is made available in module A 445, content X 470 is made available in module B 450, content Y 475 is made available in module C 455 and content Z is made available in module D 460.

Alternatively, project A 420 may be associated with UI display configuration 2 440. UI display configuration 2 440 includes module A 445, module B 450 and module C 455. Project A's 420 content W 465, content X 470 and content Y 475 may be made available via module A 445, module B 450 and module C 455, respectively. In addition, a static module 485 may be displayed regardless of the UI display configuration chosen.

At any point in the method of FIG. 4, additional actions may be performed between collections 405, work collection 410, home collection 415, project A 420, project B 425, content W 465, context X 470, content Y 475, content Z 480, UI display configurations 430, UI display configuration 1 435, UI display configuration 2 440, module A 445, module B 450, module C 455, module D 460 and static module 485.

FIG. 5 is a block diagram 500 of UI display configuration 1 435. A UI display configuration may include one or more modules. The modules within the UI display configuration may be specific to the particular UI display configuration or may be static and may appear in some or all UI display configurations. The content made available within each module specific to the UI display configuration is based upon the theme chosen. The content made available within the static module may be made available regardless of the theme chosen. The static module may be suppressed by a user or suppressed based upon criteria (e.g., the content may be made available upon a condition that a network connection is detected).

Referring to FIG. 5, UI display configuration 1 435 is displayed. UI display configuration 1 435 includes module A 445, module B 450, module C 455 and module D 460. Each module makes available content associated with the theme chosen. For example, project A 420 includes content W 465, content X 470, content Y 475 and content Z 480, which is made available in the respective modules. Content may be in any format such as, but not limited, to shortcuts, hot keys, icons, links or applications.

A static module 485 is also shown where static content that may appear in each theme is made available. The static module may include content such as, but not limited to, shortcuts, links, hot keys, icons or applications. In addition, the ability to add, edit and remove themes and collections may also be included in the static module.

At any point in the method of FIG. 5, additional actions may be performed between the UI display configuration 1 435, module A 445, module B 450, module C 455, module D 460, content W 465, content X 470, content Y 475, content Z 480 and the static module 485.

FIG. 6 is a block diagram 600 of a UI display area 605 that includes multiple active regions. The configuration of the active regions including the size and location on the screen may vary and may be adjusted based on a user preference. For example, a UI display area 605 may include three active regions (i.e., active region A 610, active region B 615 and active region C 620).

An operating system (OS) may only be aware of one region of the multiple active regions. For example the OS may only be aware of active region B 615. The active region that is known to the OS may be any one of the multiple active regions displayed.

The multiple active regions may display content that is unique to the individual active region. For example, active region A 610 may display application content A 625 (e.g., a document), while active region B 615 displays application content B 630 (e.g., an email application), and active region C 620 displays application content C 635 (e.g., a game application). The OS may only be aware of the email application in active region B 630. In addition, one or more display areas may be used to display the UI including the multiple active regions. For example, the UI including the multiple active regions may be spread across multiple monitors.

At any point in the method of FIG. 6, additional actions may be performed between the UI display 605, active region A 610, active region B 615, active region C 620, content A 625, content B 630 and content C 635.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor.

Suitable processors include, by way of example, a general purpose processor, a special purpose processor, a conventional processor, a digital signal processor (DSP), a plurality of processors, one or more processors in association with a DSP core, a controller, a microcontroller, Application Specific Integrated Circuits (ASICs), Field Programmable Gate Arrays (FPGAs) circuits, any other type of integrated circuit (IC), and/or a state machine.

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture and test semiconductor devices (e.g., processors) that embody various aspects of the present invention.

What is claimed is:

1. A method for switching content displayed by a user device between one or more themes, the method comprising:
configuring one or more display configurations and the one or more themes;
associating the one or more display configurations with the one or more themes;
choosing a theme from the one or more themes; and
generating content associated with the chosen theme via a display configuration associated with the chosen theme.

2. The method of claim 1 further comprising displaying on a monitor the content generated for display.

3. The method of claim 1 wherein the one or more display configurations include one or more modules.

4. The method of claim 3 wherein at least one module of the one or more modules has been configured to adjust the functionality provided by the at least one module responsive to the chose theme.

5. The method of claim 2 wherein the one or more modules display the content associated with the chosen theme.

6. The method of claim 1 wherein the one or more display configurations include a static module.

7. The method of claim 6 wherein the static module displays content that is not specific to the chosen theme.

8. The method of claim 1 wherein the content includes links, hot keys, triggers, icons, shortcuts or applications.

9. The method of claim 1 wherein the display configurations include one or more active regions.

10. A device for switching content displayed between one or more themes comprising:
circuitry configured to configure the one or more display configurations and the one or more themes;
circuitry configured to associate the one or more display configurations with the one or more themes;
circuitry configured to select a theme from the one or more themes; and
a circuit configured to output to a display content associated with the chosen theme via a display configuration associated with the chosen theme.

11. The device of claim 10 further comprising a monitor which receives said output and displays the content.

12. The device of claim 10 wherein the one or more display configurations include one or more modules.

13. The device of claim 12 wherein the one or more modules display the content associated with the chosen theme.

14. The device of claim 12, further comprising:
creating one or more collections of the one or more themes.

15. The device of claim 12 wherein the one or more display configurations include a static module.

16. The device of claim 15 wherein the static module displays content that is not specific to the chosen theme.

17. The device of claim 12 wherein the content includes links, hot keys, triggers, icons, shortcuts or applications.

18. The device of claim 12 wherein the display configurations include one or more active regions.

19. The device of claim 18 wherein one active region of the one or more active regions is made known to an operating system (OS).

20. A computer-readable storage medium storing a set of instructions for execution by a general purpose computer to switching content displayed between one or more themes, the set of instructions comprising:
configuring one or more display configurations and the one or more themes;
associating the one or more display configurations with the one or more themes;
choosing a theme from the one or more themes;
displaying content associated with the chosen theme via a display configuration associated with the chosen theme.
